(19) United States
(12) Patent Application Publication
(10) Pub. No.: US 2017/0233651 A1
(43) Pub. Date: Aug. 17, 2017

(54) LIQUID CRYSTAL COMPOSITION AND DISPLAY DEVICE THEREOF

(71) Applicant: JIANGSU HECHENG DISPLAY TECHNOLOGY CO., LTD., Jiangsu (CN)

(72) Inventors: Wenming HAN, Jiangsu (CN); Haibin XU, Jiangsu (CN); Dingfu MA, Jiangsu (CN); Qi LIU, Jiangsu (CN)

(73) Assignee: JIANGSU HECHENG DISPLAY TECHNOLOGY CO., LTD., Jiangsu (CN)

(21) Appl. No.: 15/503,008

(22) PCT Filed: Sep. 8, 2015
(86) PCT No.: PCT/CN2015/089170

§ 371 Date: Feb. 10, 2017

(30) Foreign Application Priority Data
Sep. 19, 2014 (CN) 201410481804.8

(51) Int. Cl. C09K 19/30

(52) U.S. Cl. CPC C09K 19/3003; C09K 2019/3004; C09K 2019/301; C09K 2019/3016

(57) ABSTRACT

The present invention discloses a liquid crystal composition, comprising: at least a first compound selected from the group consisting of a compound of general Formula I-1, a compound of general Formula I-2, and a combination thereof, and at least a second compound selected from the group consisting of a compound of general Formula II-1, a compound of general Formula II-2, a compound of general Formula II3, a compound of general Formula II-4 and a combination thereof The liquid crystal composition provided in the present invention has the properties of appropriate optical and dielectric anisotropies, high clearing point, existence of a nematic phase over a wide range of temperature, low viscosity and good high-temperature stability. The liquid crystal composition is applicable to a liquid crystal display (LCD) device, to enable the LCD device to have such properties as short response time, excellent display effect at high temperature, and others.

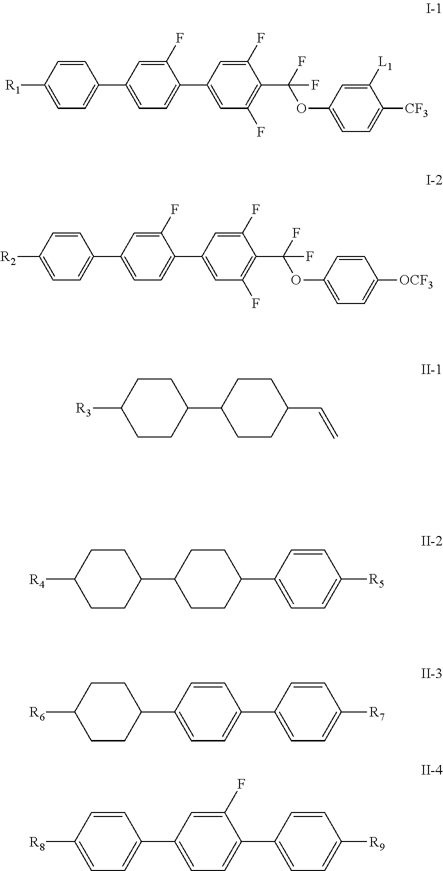

### BACKGROUND OF THE INVENTION

Field of the Invention

The present invention relates to a liquid crystal composition, and particularly to a liquid crystal composition having appropriate optical and dielectric anisotropies, high clearing point, fast response speed and good high-temperature stability, and to a liquid crystal display (LCD) comprising the liquid crystal composition.

Description of Related Art

The liquid crystal material is a mixture of organic rod-like small molecule compounds having both fluidity of a liquid and anisotropy of a crystal at a certain temperature. According to different properties of the liquid crystal materials, the liquid crystal materials of various phases are developed for use in LCD devices.

For the LCD displays, liquid crystal compounds and liquid crystal media having good chemical and thermal stability, good stability against the electric field and electromagnetic radiation, appropriate optical anisotropy, fast response speed, and low threshold voltage are desired at present. Since the liquid crystals are generally used as a mixture of a plurality of components, miscibility of the components with one another becomes particularly important. Depending on different types of batteries and application areas, the liquid crystals need to meet different requirements, such as conductivity, and dielectric and optical anisotropies, etc. However, notorious drawbacks including long response time, low resistivity and excessively high operating voltage exist in the prior art, for example, in EP0673986, DE19528106, DE19528107.

The response speed is an important evaluation index for the LCD displays. Where the response speed is too low, ghosting of the image displayed takes place. Therefore, the LCD display is required to have a fast response speed. To increase the response speed of the LCD display, decreasing the cell gap, improving the driving mode, enhancing the driving voltage, use of a fast-response liquid crystal composition, and other means, may be employed. Regardless of the means used, weakening of other performances of the LCD display is caused. For example, changing the driving mode generally leads to increased cost of driver IC and more complex circuit; the power consumption is increased with increasing driving voltage; and decreasing the cell gap causes the complicated production process, uneven cell gap and other defects, and thus causes a decreased yield of the LCD display.

The above means for improvement are all focused on the fabrication of LCD screens. Practically, the LCD panel manufacturers prefer a fast-response liquid crystal material to improve the response speed of LCD displays. However, the performances of the liquid crystal materials are mutually constrained, and increase in the response speed will often decrease the clearing point, and cause the failure of the LCD screen in working in a high temperature environment. The high and low temperature reliabilities are reduced, and the LCD display is caused to be unable to work at a low temperature in a serious case.

An objective of the present invention is to provide a liquid crystal composition, having at least one of high upper temperature and low lower temperature of the nematic phase (that is, wide phase transition temperature range); low viscosity; appropriate optical and dielectric anisotropies; and good high-temperature stability. Another objective of the present invention provides an LCD display, which contains a composition having appropriate optical and dielectric anisotropies, good high-temperature stability, and other properties, and enabling the LCD display to have such properties as short response time, excellent display effect at high temperature, and others.

### SUMMARY OF THE INVENTION

An objective of the present invention is to provide a liquid crystal composition having the properties of appropriate optical and dielectric anisotropies, high clearing point, existence of a nematic phase over a wide range of temperature, low viscosity and good high-temperature stability. The liquid crystal composition is useful in a liquid crystal display device, to enable the liquid crystal display device to have such properties as short response time, excellent display effect at high temperature, and others.

In an aspect, the present invention provides a liquid crystal composition, comprising:

a first compound, the first compound is one or more selected from the group consisting of a compound of general Formula I-1, a compound of general Formula I-2, and a combination thereof:

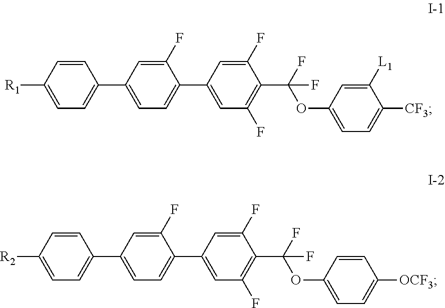

and

a second compound, the second compound is one or more selected from the group consisting of a compound of general Formula II-1, a compound of general Formula II-2, a compound of general Formula II-3, a compound of general Formula II-4, and a combination thereof:

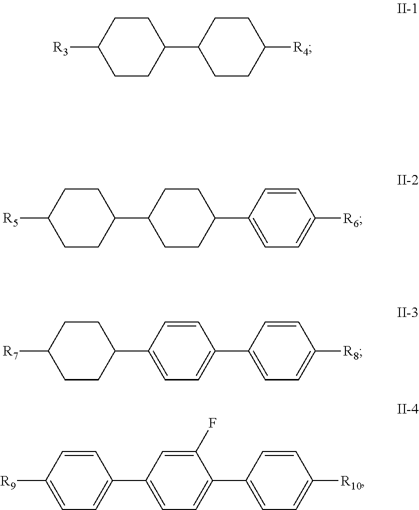

wherein:

R₁ and R₂ are the same or different, and each independently denote an alkyl group having 2 to 5 carbon atoms;

R₃, R₅, R₆, R₇, R₈, R₉ and R₁₀are the same or different, and each independently denote an alkyl or alkoxy group having 1 to 5 carbon atoms, or an alkenyl group having 2 to 5 carbon atoms;

R₄ denotes an alkenyl group having 2 to 5 carbon atoms; and

L₁ denotes H or F.

In some embodiments of the present invention, the first compound is one or more selected from the group consisting of the compounds of general Formula I-1.

In some embodiments of the present invention, the first compound is one or more selected from the group consisting of the compounds of general Formula I-2.

In some embodiments of the present invention, the second compound comprises one or more selected from the group consisting of the compounds of general Formula II-1.

In some embodiments of the present invention, the first compound accounts for 10-35% of the total weight of the liquid crystal composition.

In some embodiments of the present invention, the compound of general Formula I-1 accounts for 0-15% of the total weight of the liquid crystal composition; and the compound of general Formula I-2 accounts for 5-20% of the total weight of the liquid crystal composition.

In some embodiments of the present invention, the liquid crystal composition of the present invention further comprises:

a third compound, the third compound is one or more selected from the group consisting of a compound of general Formula III-1, a compound of general Formula III-2, a compound of general Formula III-3 and a combination thereof:

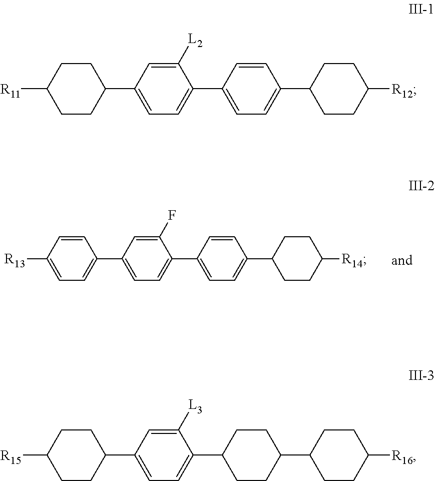

wherein:

R₁₁, R₁₂, R_{13,} R₁₄,R₁₅ and R₁₆ are the same or different, and each independently denote an alkyl group having 1 to 5 carbon atoms, or an alkenyl group having 2 to 5 carbon atoms;

L₂ and L₃ are the same or different, and each independently denote H or F.

In some embodiments of the present invention, the third compound accounts for 0-20% of the total weight of the liquid crystal composition.

In some embodiments of the present invention, the first compound accounts for 10-90% of the total weight of the liquid crystal composition; and the second compound accounts for 10-90% of the total weight of the liquid crystal composition.

In some embodiments of the present invention, the first compound accounts for 10-90% of the total weight of the liquid crystal composition; the second compound accounts for 10-90% of the total weight of the liquid crystal composition; and the third compound accounts for 0-15% of the total weight of the liquid crystal composition.

In some embodiments of the present invention, the first compound accounts for 10-45% of the total weight of the liquid crystal composition; and the second compound accounts for 55-90% of the total weight of the liquid crystal composition.

In some embodiments of the present invention, the first compound accounts for 10-45% of the total weight of the liquid crystal composition; the second compound accounts for 55-90% of the total weight of the liquid crystal composition; and the third compound accounts for 0-10% of the total weight of the liquid crystal composition.

In some embodiments of the present invention, as a particularly preferred solution, particularly preferably, the compound of general Formula I accounts for 10-35% of the total weight of the liquid crystal composition.

In some embodiments of the present invention, as a particularly preferred solution, particularly preferably, the compound of general Formula I-1 accounts for 0-15% of the total weight of the liquid crystal composition; and the compound of general Formula I-2 accounts for 5-20% of the total weight of the liquid crystal composition.

In some embodiments of the present invention, the compound of general Formula I-1 is preferably one or more selected from the group consisting of:

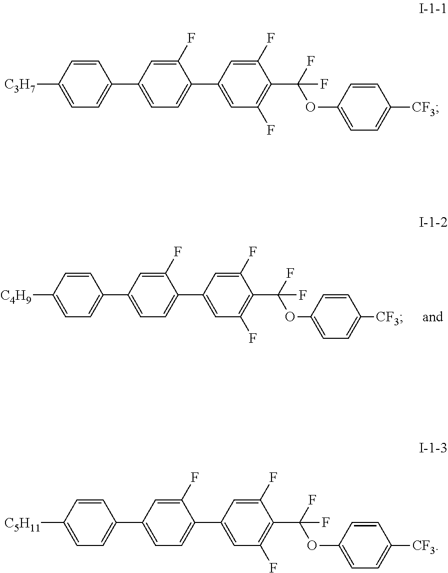

In some embodiments of the present invention, the compound of general Formula I-2 is preferably one or more selected from the group consisting of:

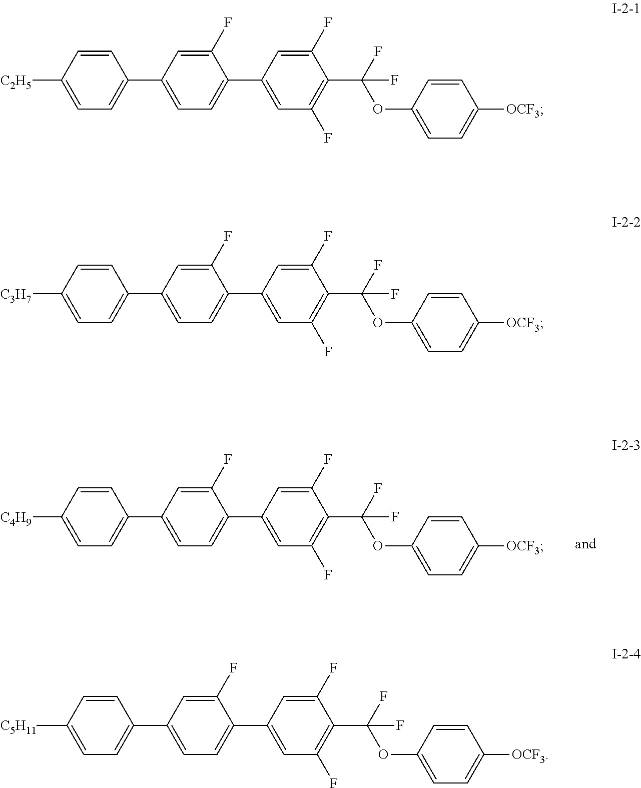

In some embodiments of the present invention, the compound of general Formula II-1 is one or more selected from the group consisting of:

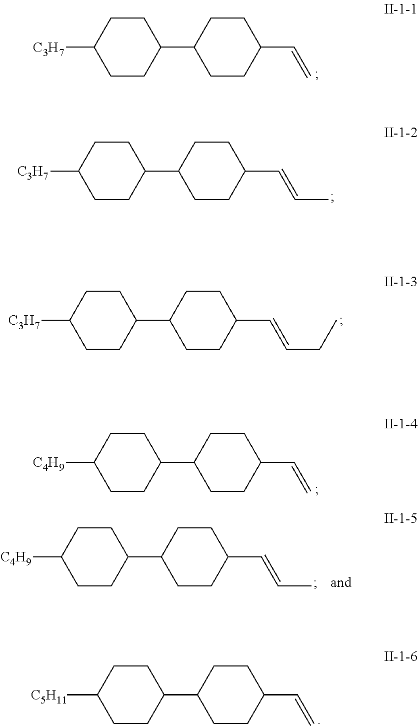

In some embodiments of the present invention, the compound of general Formula II-2 is one or more selected from the group consisting of:

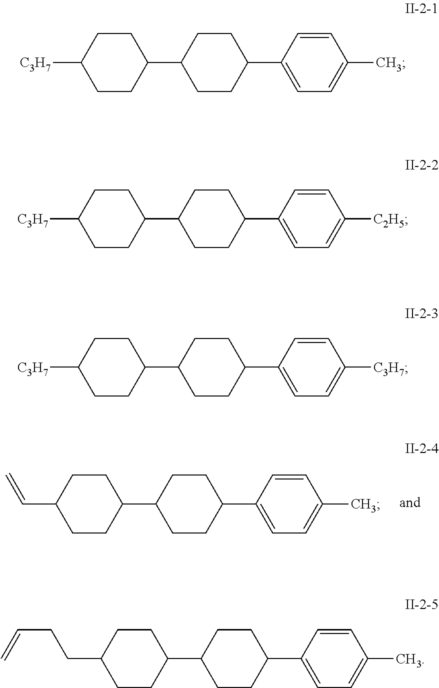

As a particularly preferred solution, the compound of general Formula II-2 is particularly preferably one or more selected from the group consisting of:

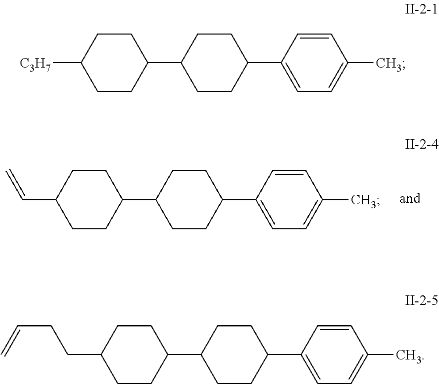

In some embodiments of the present invention, the compound of general Formula II-3 is one or more selected from the group consisting of:

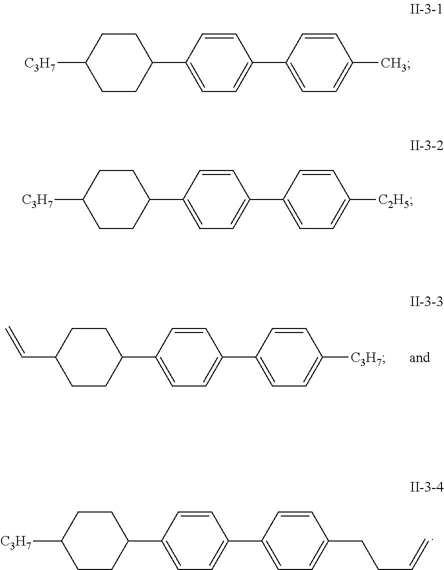

As a particularly preferred solution, the compound of general Formula II-3 is particularly preferably one or more selected from the group consisting of:

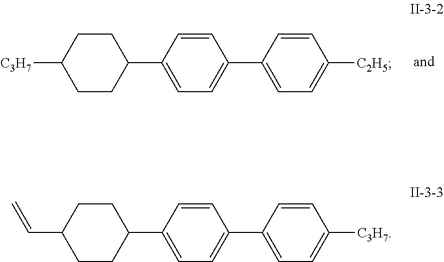

In some embodiments of the present invention, the compound of general Formula II-4 is one or more selected from the group consisting of:

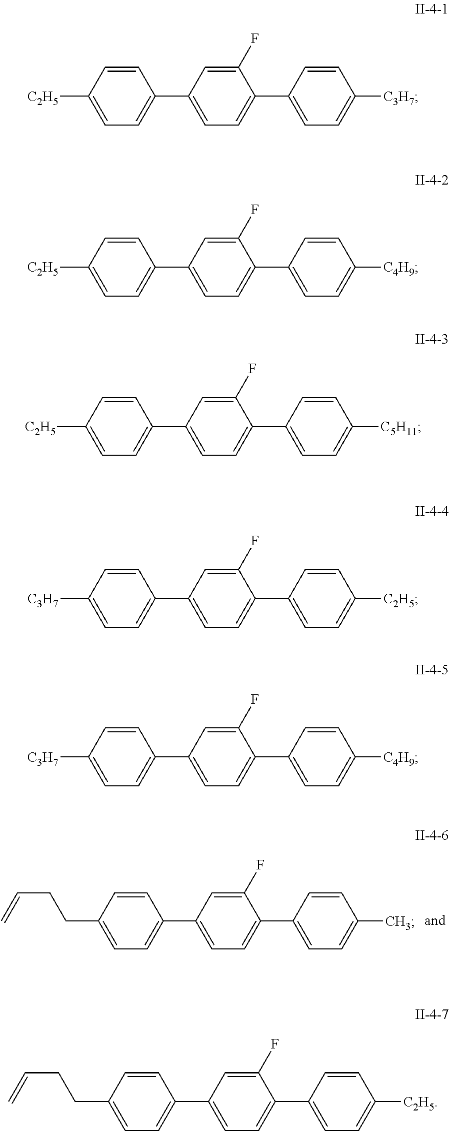

As a particularly preferred solution, the compound of general Formula II-4 is particularly preferably one or more selected from the group consisting of:

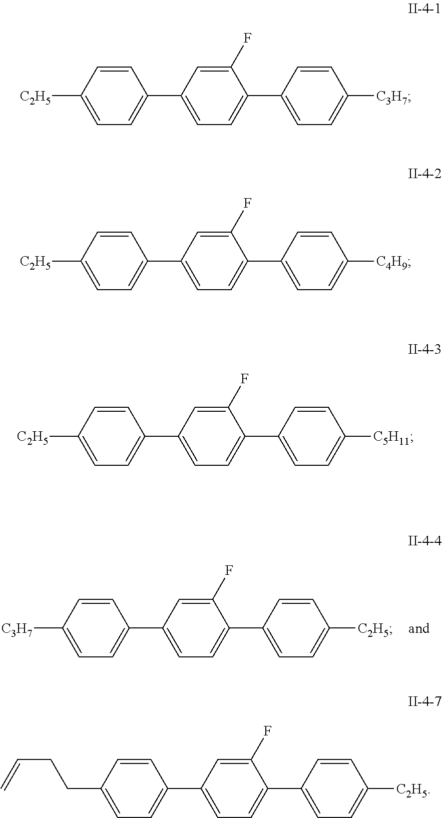

In some embodiments of the present invention, the compound of general Formula III-1 is one or more selected from the group consisting of:

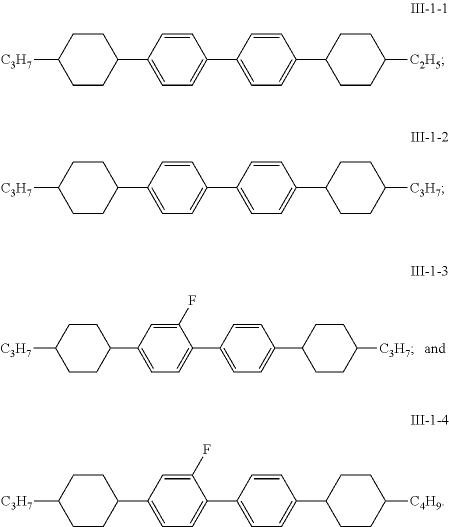

As a particularly preferred solution, the compound of general Formula III-1 is particularly preferred the compound III-1-2.

In some embodiments of the present invention, the compound of general Formula III-2 is one or more selected from the group consisting of:

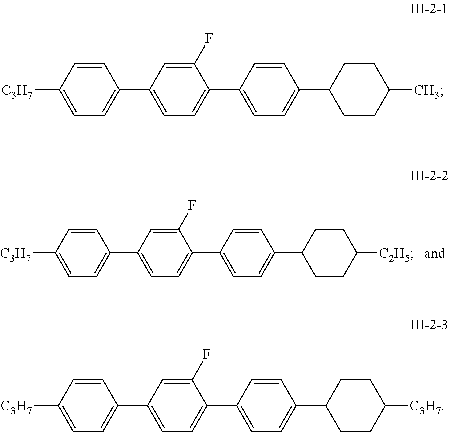

As a particularly preferred solution, the compound of general Formula III-2 is particularly preferred the compound III2-2.

In some embodiments of the present invention, the compound of general Formula III-3 is one or more selected from the group consisting of:

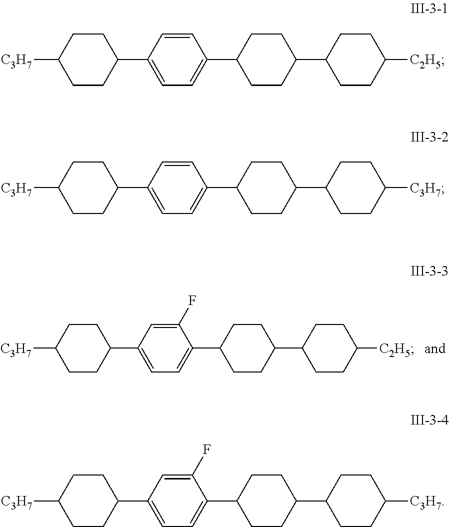

As a particularly preferred solution, the compound of general Formula III-3 is particularly preferred the compound III-3-1.

The present invention further provides an LCD comprising the liquid crystal composition of the present invention.

It is confirmed through experiments in the present invention that the liquid crystal composition of the present invention has the properties of appropriate optical and dielectric anisotropies, high clearing point, existence of a nematic phase over a wide range of temperature, low viscosity and high thermal stability.

Unless specifically stated otherwise, in the present invention, the ratio is weight ratio, the temperature is in degrees Celsius, and the response time data is tested with a cell gap of 7 μm.

### DETAILED DESCRIPTION OF THE INVENTION

Hereinafter, the present invention is described with reference to specific embodiments. It should be noted that the examples below are illustrative of the present invention, and provided merely for explaining, instead of limiting the present invention. Other combinations and various improvements may be made within the concept and without departing from the spirit and scope of the present invention.

For ease of description, in the following examples, the group structures contained in the liquid crystal compound are designated by the codes listed in Table 1:

TABLE 1
Codes for group structures contained in the liquid crystal compound

| Unit structure of the group | Code | Name of the group |
|---|---|---|
| 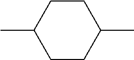 | C | 1,4-cyclohexylene |
| 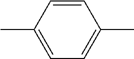 | P | 1,4-phenylene |
| 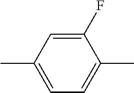 | G | 2-fluoro-1,4-phenylene |
| 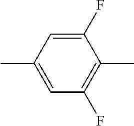 | U | 2,6-difluoro-1,4-phenylene |
| —F | F | Fluoro substituent |
| —COO— | E | Ester bridge |
| —CF₃ | CF3 | Trifluoromethyl |
| —OCF₃ | OCF3 | Trifluoromethoxy |
| —CF₂O— | Q | Difluoromethoxy |
| —CH═CH— | V | Vinyl |
| —CH₂CH₂— | 2 | Ethane bridge |
| —CₙH₂ₙ₊₁ or —CₘH₂ₘ₊₁ | n or m | Alkyl |

Taking a compound having a structural formula below as an example:

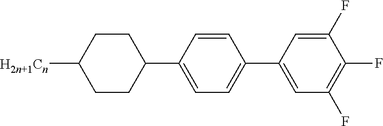

if the structural formula is designated by the codes in Table 1, it may be expressed as nCPUF, where n denotes the number of carbon atoms contained in the alkyl group at the left end, for example, when n is “3”, the alkyl group is -C₃H₇; and C denotes cyclohexylene.

The test items in the following examples are abbreviated as follows:
Cp (° C.): Clearing point (nematic-isotropic phase transition temperature)
Δn: Optical anisotropy (589 nm, 20° C.)
ΔΔε: Dielectric anisotropy (1 KHz, 25° C.)
γ1: Rotary viscosity (mPa*s, at 20° C.)
VHR Voltage holding ratio (%)
(starting):
VHR (150° C.): Voltage holding ratio (%) determined after 1 h degradation at 150° C.

The refractivity anisotropy is measured using abbe refractometer under sodium lamp (589 nm) light source at 20° C. The dielectric test cell is the type TN90, and the cell gap is 7 μm.

Δε=ε∥-ε⊥, wherein ell is the dielectric constant parallel to the molecular axis, and ε⊥ is the dielectric constant perpendicular to the molecular axis; the test conditions include 25° C. and 1 KHz; the dielectric test cell is the type TN90, and the cell gap is 7 μm.

VHR (starting) is tested by TOYO6254 liquid crystal physical property evaluation system, where the test temperature is 60° C., the test voltage is 5V, and the test time is 166.7 ms; and VHR (150° C.) is tested by TOYO6254 liquid crystal physical property evaluation system after 1 h degradation of the liquid crystal at 150° C., where the test temperature is 60° C., the test voltage is 5 V, and the test time is 166.7 ms.

Each of the components used in the following examples can be synthesized by a known method or is commercially available. These synthesis techniques are conventional and the resulting liquid crystal compounds are tested to conform to the standards for electronic compounds.

liquid crystal composition is prepared according to a mixing ratio of the liquid crystal compounds defined in the following examples. The liquid crystal composition is prepared by a conventional method in the art, for example, mixing according to the defined ratio by heating, ultrasonicating, and suspending, etc.

### COMPARATIVE EXAMPLE 1

The liquid crystal composition of Comparative Example 1 was prepared with the compounds in percentages by weight shown in Table 2, and then filled between two substrates of an LCD display for performance test. The test data is shown in a table below.

TABLE 2
Formulation of liquid crystal composition and
performances tested

| | | | Test result | |
|---|---|---|---|---|
| Code of | Type of | | of performance | |
| component | compound | Content, % | parameters | |
| 3CCV | II-1-1 | 37 | Cp | 75.0 |
| 1PP2V1 | | 7 | Δn | 0.1152 |
| 3PUQUF | | 15 | Δε | 5.0 |
| 3CGUF | | 3 | γ1 | 59 |
| 2PGP3 | II-4-1 | 5 | VHR (starting) | 98.3% |
| 2PGP4 | II-4-2 | 7 | VHR (150° C.) | 90.7% |
| VCCP1 | II-2-4 | 18 | | |
| 3CCGUF | | 8 | | |

| | |
|---|---|
| In total | 100 |

### EXAMPLE 1

The liquid crystal composition of Example 1 was prepared with the compounds in percentages by weight shown in Table 3, and then filled between two substrates of an LCD display for performance test. The test data is shown in a table below.

TABLE 3
Formulation of liquid crystal composition and
performances tested

| | | | Test result | |
|---|---|---|---|---|
| Code of | Type of | | of performance | |
| component | compound | Content, % | parameters | |
| 3CCV | II-1-1 | 40 | Cp | 76.2 |
| 4CCV | II-1-4 | 10 | Δn | 0.116 |
| 5CCV | II-1-6 | 10 | Δε | 5.0 |
| 3CPP2 | II-3-2 | 4 | γ1 | 51 |
| 2PGP3 | II-4-1 | 4 | VHR (starting) | 98.5% |
| 2PGP4 | II-4-2 | 4 | VHR (150° C.) | 97.7% |
| 2PGP5 | II-4-3 | 4 | | |
| 3CCP1 | II-2-1 | 4 | | |
| 2PGUQPOCF3 | I-2-1 | 5 | | |
| 3PGUQPOCF3 | I-2-2 | 6 | | |
| 4PGUQPOCF3 | I-2-3 | 6 | | |
| 5PGUQPOCF3 | I-2-4 | 3 | | |

| | |
|---|---|
| In total | 100 |

### EXAMPLE 2

The liquid crystal composition of Example 2 was prepared with the compounds in percentages by weight shown in Table 4, and then filled between two substrates of an LCD display for performance test. The test data is shown in a table below.

TABLE 4
Formulation of liquid crystal composition and
performances tested

| | | | Test result | |
|---|---|---|---|---|
| Code of | Type of | | of performance | |
| component | compound | Content, % | parameters | |
| 3CCV | II-1-1 | 40 | Cp | 80.0 |
| 4CCV | II-1-4 | 10 | Δn | 0.119 |
| 5CCV | II-1-6 | 11 | Δε | 5.0 |
| 3CPP2 | II-3-2 | 3 | γ1 | 54 |
| 2PGP3 | II-4-1 | 5 | VHR (starting) | 98.5% |
| 2PGP4 | II-4-2 | 4 | VHR (150° C.) | 98.1% |
| V2PGP2 | II-4-7 | 4 | | |
| 3PGPC2 | III-2-2 | 2 | | |
| 3CPPC3 | III-1-2 | 2 | | |
| 2PGUQPOCF3 | I-2-1 | 5 | | |
| 3PGUQPOCF3 | I-2-2 | 6 | | |
| 4PGUQPOCF3 | I-2-3 | 4 | | |
| 3PGUQPCF3 | I-1-1 | 4 | | |

| | |
|---|---|
| In total | 100 |

### EXAMPLE 3

The liquid crystal composition of Example 3 was prepared with the compounds in percentages by weight shown in Table 5, and then filled between two substrates of an LCD display for performance test. The test data is shown in a table below.

TABLE 5
Formulation of liquid crystal composition and
performances tested

| | | | Test result | |
|---|---|---|---|---|
| Code of | Type of | | of performance | |
| component | compound | Content, % | parameters | |
| 3CCV | II-1-1 | 40 | Cp | 81.5 |
| 4CCV | II-1-4 | 10 | Δn | 0.119 |
| 5CCV | II-1-6 | 8 | Δε | 4.9 |
| 2PGP3 | II-4-1 | 5 | γ1 | 57 |
| 2PGP4 | II-4-2 | 4 | VHR (starting) | 98.4% |
| 2PGP5 | II-4-3 | 4 | VHR (150° C.) | 98.1% |
| 3PGPC2 | III-2-2 | 2 | | |
| VCCP1 | II-2-4 | 7 | | |
| 2PGUQPOCF3 | I-2-1 | 6 | | |
| 3PGUQPOCF3 | I-2-2 | 5 | | |
| 4PGUQPOCF3 | I-2-3 | 4 | | |
| 5PGUQPOCF3 | I-2-4 | 5 | | |

| | |
|---|---|
| In total | 100 |

### COMPARATIVE EXAMPLE 2

The liquid crystal composition of Comparative Example 2 was prepared with the compounds in percentages by weight shown in Table 6, and then filled between two substrates of an LCD display for performance test. The test data is shown in a table below.

TABLE 6
Formulation of liquid crystal composition and
performances tested

| | | | |
|---|---|---|---|
| | | | Test result |
| Code of | Type of | | of performance |
| component | compound | Content, % | parameters |

| | | | |
|---|---|---|---|
| 7CPF | 6 | Cp | 92.0 |
| 5CC3 | 6 | Δn | 0.086 |
| 2CCPOCF3 | 8 | Δε | 7.3 |
| 3CCPOCF3 | 8 | γ1 | 125 |
| 4CCPOCF3 | 7 | VHR (starting) | 98.4% |
| 5CCPOCF3 | 8 | VHR (150° C.) | 86.9% |
| 2CCUF | 12 | | |
| 3CCUF | 11 | | |
| 5CCUF | 8 | | |
| 3CGUF | 5 | | |
| 3CCEGF | 7 | | |
| 5CCEGF | 5 | | |
| 3CPGF | 9 | | |

| | |
|---|---|
| In total | 100 |

### EXAMPLE 4

The liquid crystal composition of Example 4 was prepared with the compounds in percentages by weight shown in Table 7, and then filled between two substrates of an LCD display for performance test. The test data is shown in a table below.

TABLE 7
Formulation of liquid crystal composition and
performances tested

| | | | Test result | |
|---|---|---|---|---|
| Code of | Type of | | of performance | |
| component | compound | Content, % | parameters | |
| 3CCV | II-1-1 | 25 | Cp | 101.3 |
| 5CCV | II-1-6 | 8 | Δn | 0.101 |
| VCCP1 | II-2-4 | 12 | Δε | 7.4 |
| 3CCP1 | II-2-1 | 6 | γ1 | 96 |
| V2CCP1 | II-2-5 | 6 | VHR (starting) | 98.4% |
| 3CPCC2 | III-3-1 | 5 | VHR (150° C.) | 96.9% |
| 3PGPC2 | III-2-2 | 3 | | |
| 2PGUQPOCF3 | I-2-1 | 5 | | |
| 3PGUQPOCF3 | I-2-2 | 5 | | |
| 4PGUQPOCF3 | I-2-3 | 5 | | |
| 5PGUQPOCF3 | I-2-4 | 5 | | |
| 3PGUQPCF3 | I-1-1 | 5 | | |
| 4PGUQPCF3 | I-1-2 | 5 | | |
| 5PGUQPCF3 | I-1-3 | 5 | | |

| | |
|---|---|
| In total | 100 |

### EXAMPLE 5

The liquid crystal composition of Example 5 was prepared with the compounds in percentages by weight shown in Table 8, and then filled between two substrates of an LCD display for performance test. The test data is shown in a table below.

TABLE 8
Formulation of liquid crystal composition and
performances tested

| | | | Test result | |
|---|---|---|---|---|
| Code of | Type of | | of performance | |
| component | compound | Content, % | parameters | |
| 3CCV | II-1-1 | 25 | Cp | 96.4 |
| 5CCV | II-1-6 | 9 | Δn | 0.098 |
| VCCP1 | II-2-4 | 12 | Δε | 7.2 |
| 3CCP1 | II-2-1 | 6 | γ1 | 91 |
| V2CCP1 | II-2-5 | 6 | VHR (starting) | 98.4% |
| 3CPCC2 | III-3-1 | 5 | VHR (150° C.) | 96.7% |
| 3PGP2 | II-4-5 | 3 | | |
| 2PGUQPOCF3 | I-2-1 | 5 | | |
| 3PGUQPOCF3 | I-2-2 | 5 | | |
| 4PGUQPOCF3 | I-2-3 | 5 | | |
| 5PGUQPOCF3 | I-2-4 | 5 | | |
| 3PGUQPCF3 | I-1-1 | 5 | | |
| 4PGUQPCF3 | I-1-2 | 5 | | |
| 5PGUQPCF3 | I-1-3 | 4 | | |

| | |
|---|---|
| In total | 100 |

### EXAMPLE 6

The liquid crystal composition of Example 6 was prepared with the compounds in percentages by weight shown in Table 9, and then filled between two substrates of an LCD display for performance test. The test data is shown in a table below.

TABLE 9
Formulation of liquid crystal composition and
performances tested

| | | | Test result | |
|---|---|---|---|---|
| Code of | Type of | | of performance | |
| component | compound | Content, % | parameters | |
| 3CCV | II-1-1 | 25 | Cp | 92.4 |
| 5CCV | II-1-6 | 12 | Δn | 0.09 |
| VCCP1 | II-2-4 | 14 | Δε | 7.3 |
| 3CCP1 | II-2-1 | 6 | γ1 | 88 |
| V2CCP1 | II-2-5 | 6 | VHR (starting) | 98.5% |
| VCPP3 | II-3-3 | 3 | VHR (150° C.) | 96.9% |
| 2PGUQPOCF3 | I-2-1 | 6 | | |
| 3PGUQPOCF3 | I-2-2 | 5 | | |
| 4PGUQPOCF3 | I-2-3 | 5 | | |
| 5PGUQPOCF3 | I-2-4 | 4 | | |
| 3PGUQPCF3 | I-1-1 | 6 | | |
| 4PGUQPCF3 | I-1-2 | 5 | | |
| 5PGUQPCF3 | I-1-3 | 3 | | |

| | |
|---|---|
| In total | 100 |

As can be known from the data obtained in the examples above, the liquid crystal composition provided in the present invention has appropriate optical and dielectric anisotropies, existence of a nematic phase over a wide range of temperature, high clearing point, fast response speed and good high-temperature stability, and is applicable to an LCD display. Compared with Comparative Examples 1 and 2, when the optical anisotropy, the dielectric anisotropy and the clearing point are similar, the liquid crystal composition provided in the present invention has a further shorter response time and better high-temperature stability, and can meet the requirement of fast response speed and excellent display effect at high temperature for an LCD display. Therefore, significant technological advancements are achieved.

1. A liquid crystal composition, comprising:
a first compound, which is one or more selected from the group consisting of a compound of general Formula I-1, a compound of general Formula I-2, and a combination thereof: 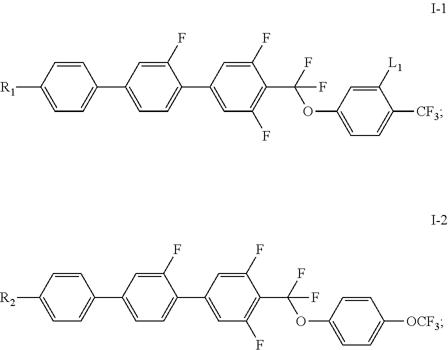
and
a second compound, which is one or more selected from the group consisting of a compound of general Formula II-1, a compound of general Formula II-2, a compound of general Formula II-3, a compound of general Formula II-4, and a combination thereof: 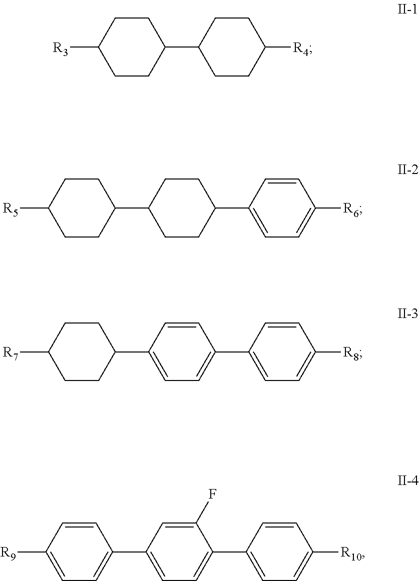
wherein:
R₁ and R₂ are the same or different, and each independently denote an alkyl group having 2 to 5 carbon atoms;
R₃, R₅, R₆, R₇, R₈, R₉ and R₁₀ are the same or different, and each independently denote an alkyl or alkoxy group having 1 to 5 carbon atoms, or an alkenyl group having 2 to 5 carbon atoms;
R₄ denotes an alkenyl group having 2 to 5 carbon atoms; and
L₁ denotes H or F.

2. The liquid crystal composition according to claim 1, wherein the first compound is one or more selected from the compounds of general Formula I-1.

3. The liquid crystal composition according to claim 1, wherein the first compound is one or more selected from the compounds of general Formula I-2.

4. The liquid crystal composition according to claim 1, wherein the second compound comprises one or more selected from the compounds of general Formula II-1.

5. The liquid crystal composition according to claim 1, wherein the liquid crystal composition further comprising:
a third compound, which is one or more selected from the group consisting of a compound of general Formula III-1, a compound of general Formula III-2, a compound of general Formula III-3 and a combination thereof: 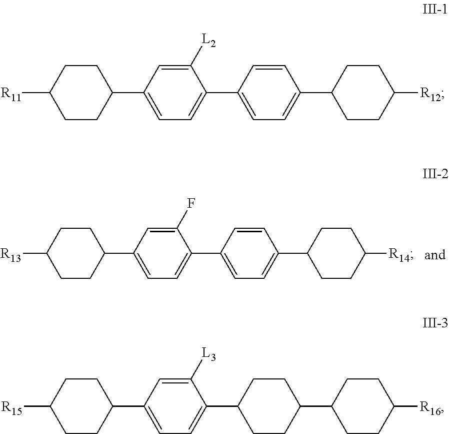
wherein:
R₁₁, R₁₂, R₁₃, R₁₄, R₁₅ and R₁₆ are the same or different, and each independently denote an alkyl group having 1 to 5 carbon atoms, or an alkenyl group having 2 to 5 carbon atoms;
L₂ and L₃ are the same or different, and each independently denote H or F.

6. The liquid crystal composition according to claim 5, wherein the third compound accounts for 0-20% of the total weight of the liquid crystal composition.

7. The liquid crystal composition according to claim 1, wherein the first compound accounts for 10-90% of the total weight of the liquid crystal composition, and the second compound accounts for 10-90% of the total weight of the liquid crystal composition.

8. The liquid crystal composition according to claim 5, wherein the first compound accounts for 10-90% of the total weight of the liquid crystal composition; the second compound accounts for 10-90% of the total weight of the liquid crystal composition; and the third compound accounts for 0-15% of the total weight of the liquid crystal composition.

9. The liquid crystal composition according to claim 7, wherein the first compound accounts for 10-45% of the total weight of the liquid crystal composition, and the second compound accounts for 55-90% of the total weight of the liquid crystal composition.

10. The liquid crystal composition according to claim 8, wherein the first compound accounts for 10-45% of the total weight of the liquid crystal composition; the second compound accounts for 55-90% of the total weight of the liquid crystal composition; and the third compound accounts for 0-10% of the total weight of the liquid crystal composition.

11. The liquid crystal composition according to claim 1, wherein the compound of general Formula I-1 is one or more selected from the group consisting of: 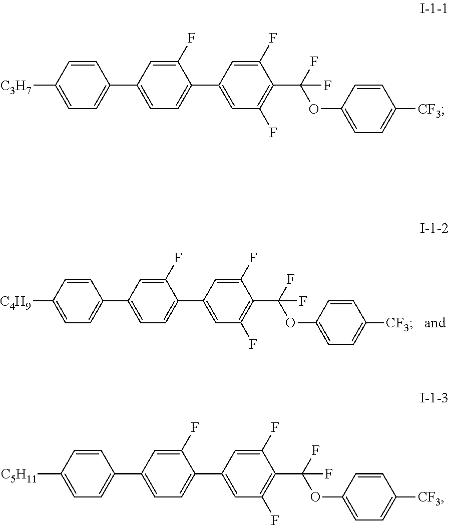
and
the compound of general Formula I-2 is one or more selected from the group consisting of:

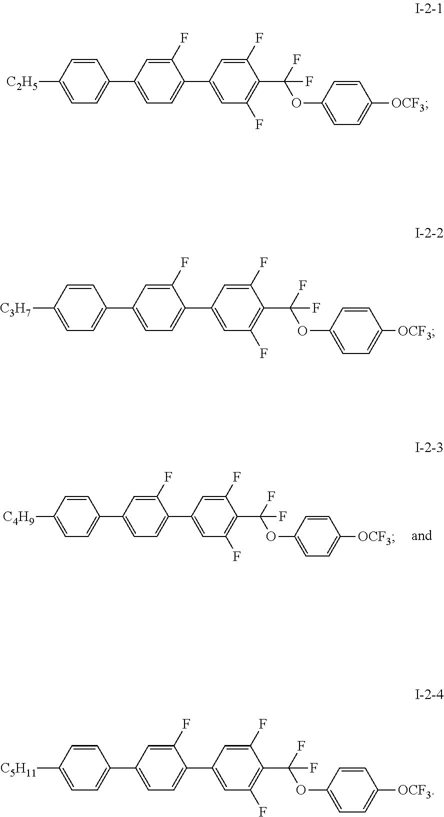

12. The liquid crystal composition according to claim 1, wherein the compound of general Formula II-1 is one or more selected from the group consisting of: 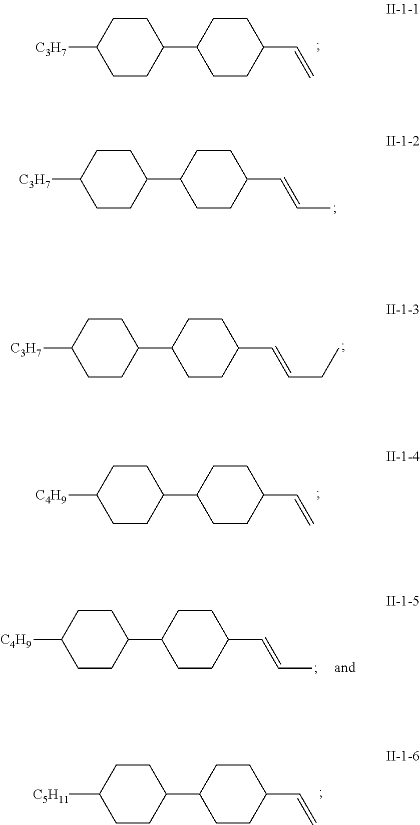
the compound of general Formula II-2 is one or more selected from the group consisting of: 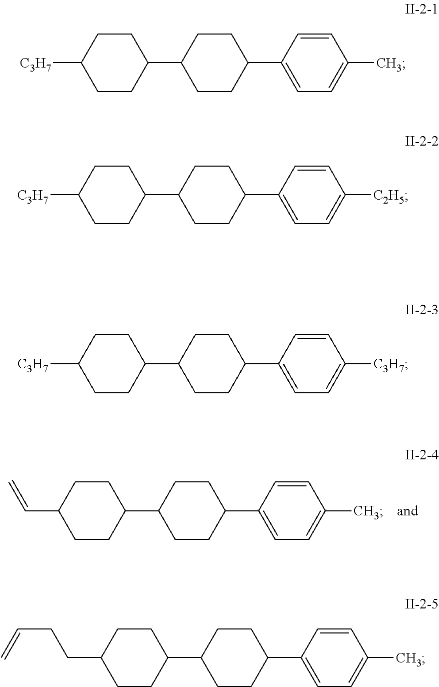
the compound of general Formula II-3 is one or more selected from the group consisting of: 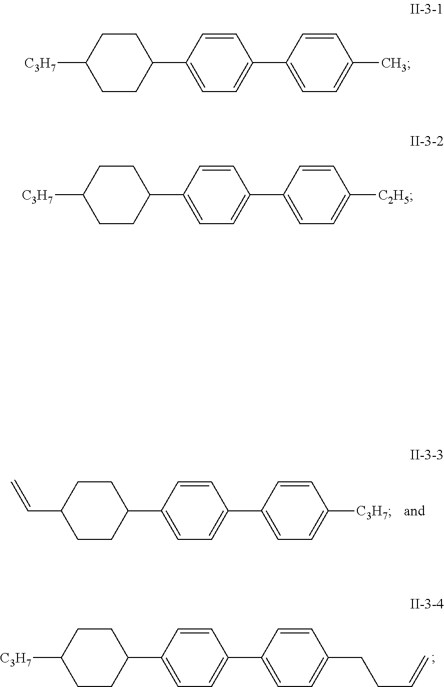
and
the compound of general Formula II-4 is one or more selected from the group consisting of:

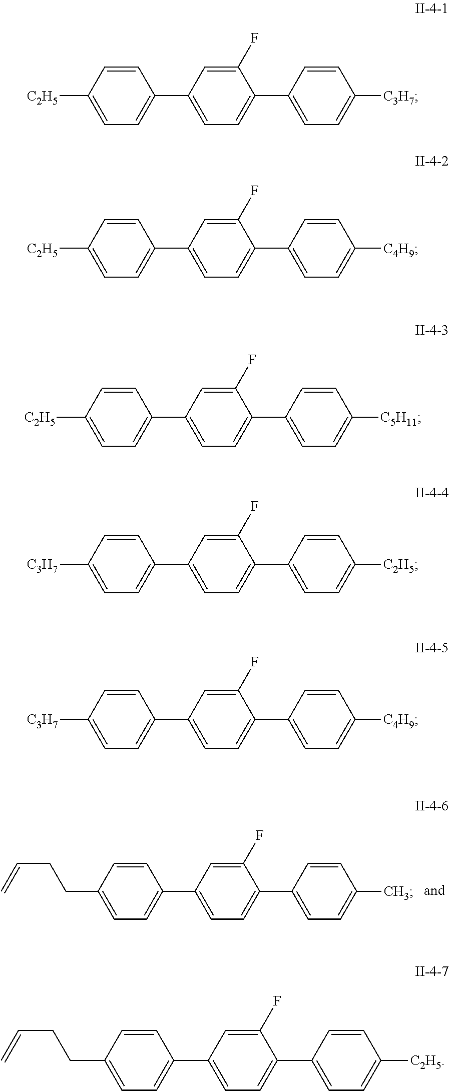

13. The liquid crystal composition according to claim 5, wherein the compound of general Formula III-1 is one or more selected from the group consisting of: 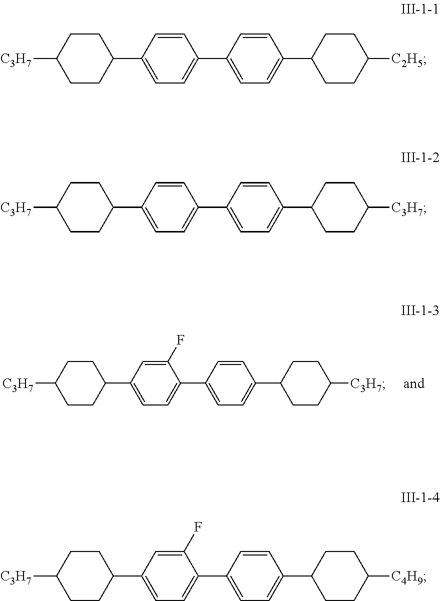
the compound of general Formula III-2 is one or more selected from the group consisting of: 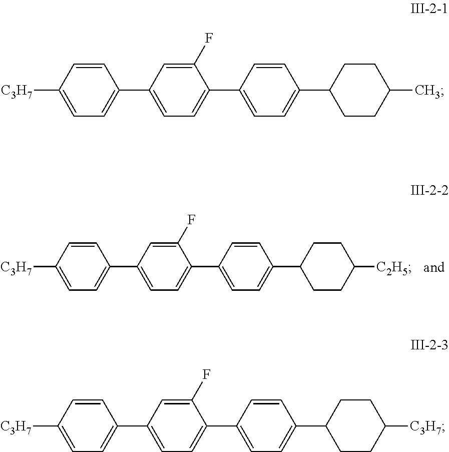
the compound of general Formula III-3 is one or more selected from the group consisting of:

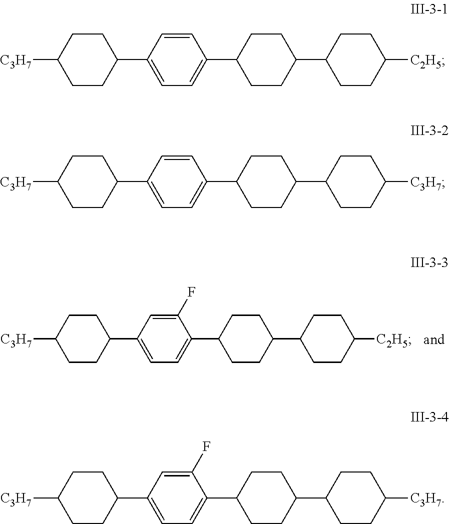

14. The liquid crystal composition according to claim 9, wherein the first compound accounts for 10-35% of the total weight of the liquid crystal composition.

15-17. (canceled)

18. The liquid crystal composition according to claim 10, wherein the first compound accounts for 10-35% of the total weight of the liquid crystal composition.

19. The liquid crystal composition according to claim 14, wherein the compound of general Formula I-1 accounts for 0-15% of the total weight of the liquid crystal composition; and the compound of general Formula I-2 accounts for 5-20% of the total weight of the liquid crystal composition.

20. The liquid crystal composition according to claim 18, wherein the compound of general Formula I-1 accounts for 0-15% of the total weight of the liquid crystal composition; and the compound of general Formula I-2 accounts for 5-20% of the total weight of the liquid crystal composition.

21. A liquid crystal display (LCD), wherein it comprises the liquid crystal composition according to claim 1.
